(19) United States
(12) Patent Application Publication
(10) Pub. No.: US 2025/0012703 A1
(43) Pub. Date: Jan. 9, 2025

(54) CONTROL OF FLUID EJECTION FROM A MICROFLUIDIC DEVICE

(71) Applicant: Hewlett-Packard Development Company, L.P., Spring, TX (US)

(72) Inventors: Yang Lei, Palo Alto, CA (US); Joshua M. Yu, Corvallis, OR (US); Timothy Merritt Holt, Corvallis, OR (US); Angela Bakkom, Corvallis, OR (US)

(73) Assignee: Hewlett-Packard Development Company, L.P., Spring, TX (US)

(21) Appl. No.: 18/702,172

(22) PCT Filed: Oct. 29, 2021
(86) PCT No.: PCT/US2021/057276

§ 371 Date: Apr. 17, 2024

(51) Int. Cl. G01N 15/1031; G01N 15/01; G06V 20/69

(52) U.S. Cl. CPC G01N 15/1031; G01N 15/01; G06V 20/693; G06V 20/695; G06V 20/698

(57) ABSTRACT

A non-limiting example method for control of fluid ejection from a microfluidic device includes firing a microfluidic ejector of a microfluidic device to expel a fluid from a channel of the microfluidic device. In response to detecting an instance of signal change from an impedance sensor disposed in the channel, the method includes controlling fluid ejection from the microfluidic ejector and capturing an image of the channel with an imaging apparatus. Using the captured image, a determination is made as to whether passage of a cell into the channel is associated with the instance of signal change from the impedance sensor. Based on the determination, the microfluidic ejector may fire to dispense the fluid from the channel into a reservoir.

### BACKGROUND

Microfluidics applies across a variety of disciplines including engineering, physics, chemistry, microtechnology and biotechnology. Microfluidics involves the study of small volumes, e.g., microliters, picoliters, or nanoliters, of fluid and how to manipulate, control and use such small volumes of fluid in various microfluidic systems and devices. For example, microfluidic biochips are used in the field of molecular biology to integrate assay operations for purposes such as analyzing enzymes and deoxyribonucleic acid (DNA), detecting biochemical toxins and pathogens, diagnosing diseases, etc.

Flow cytometry is a technique that is used to determine certain physical and chemical properties of microscopic particles by sensing certain optical properties of the particles. Flow cytometry may be used in a wide variety of applications including hematology, immunology, genetics, food science, pharmacology, microbiology, parasitology and oncology among others.

### BRIEF DESCRIPTION OF THE DRAWINGS

FIG. 1 illustrates an example method for control of fluid ejection from a microfluidic device, in accordance with the present disclosure.

FIG. 2 illustrates an example apparatus capable of control of fluid ejection from a microfluidic device, in accordance with the present disclosure.

FIG. 3 illustrates an example flow diagram for control of fluid ejection from a microfluidic device, in accordance with the present disclosure.

FIG. 4 is a block diagram illustrating an example method for control of fluid ejection from a microfluidic device, in accordance with the present disclosure.

FIG. 5 is a block diagram illustrating an example method for sorting of cells by cell type via control of fluid ejection from a microfluidic device, in accordance with the present disclosure.

FIG. 6 illustrates an example system for control of fluid ejection from a microfluidic device, in accordance with the present disclosure.

FIG. 7 illustrates an example system for control of fluid ejection from a microfluidic device, in accordance with the present disclosure.

FIG. 8 illustrates a portion of an example apparatus including multiple impedance sensors, in accordance with the present disclosure.

FIG. 9 illustrates an example computing device for control of fluid ejection from a microfluidic device, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Cell sorting is the process of taking cells from an organism and separating the cells according to type. The cells may be separated based on differences in cell size, morphology, and surface protein expression, for instance. The resulting homologous populations of cells may have applications in research and therapeutics. For instance, homologous populations of cells may be used for profiling immune responses and for sorting cancer cells. Additional non-limiting examples of applications that may use cell sorting include methods and systems for screening clustered regularly interspaced short palindromic repeat (CRISPR) libraries, methods and systems for purifying engineered microbes, as well as methods and systems for enriching nuclei for single cell epigenomics, among others.

Cell sorting may also be used in the development of monoclonal antibodies. Monoclonal antibodies may be used for antigen detection and may be used as antibody therapies for a number of conditions including autoimmune disorders and cancer. In the biopharmaceutical production of monoclonal antibodies, dispensing a single cell into a reservoir such as a well of a microwell plate, may be beneficial for growing homogeneous, monoclonal cell lines. Single cell dispensing may be beneficial because production of a cell line from a single cell may result in production of monoclonal cell lines with the same progeny, produced by a method that is highly automated, has a high throughput, is highly flexible, has a low impact on the cell integrity, and does not result in cross-contamination. Moreover, accurately identifying and isolating different cell types in a fluid sample may allow for a rapid and cost-effective method for generating a plurality of monoclonal cell lines, each with a different respective progeny.

Proof and/or verification of single cell dispensing in the production of monoclonal antibodies may be beneficial for regulatory approval and/or may be desired by customers to verify the quality of the monoclonal antibodies. When providing proof and/or verification of single cell dispensing during growth of monoclonal cell lines, an image of the cell being dispensed (and therefore used for the production of the resultant cell line) may be provided. As such, capturing images of cells during cell dispensing may assist in proof and/or verification in the production of monoclonal cell lines. In accordance with the present disclosure, control of fluid ejection from a microfluidic device may allow for separation of single cells in a fluid containing sometimes a plurality of cells and/or cell types. Moreover, control of fluid ejection from a microfluidic device in accordance with the present disclosure may allow for image capture of single cells dispensed into disparate reservoirs.

A non-limiting example method for control of fluid ejection from a microfluidic device in accordance with the present disclosure includes firing a microfluidic ejector of a microfluidic device to expel a fluid from a channel of the microfluidic device. In response to detecting an instance of signal change from an impedance sensor disposed in the channel, the method may include controlling fluid ejection from the microfluidic ejector and capturing an image of the channel with an imaging apparatus. Using the captured image, the method may include determining whether passage of a cell into the channel is associated with the instance of signal change from the impedance sensor. Based on the determination, the method may include firing the microfluidic ejector to dispense the fluid from the channel into a reservoir.

In some examples, the method includes firing the microfluidic ejector to dispense the fluid from the channel into a first reservoir in response to a determination that a cell is not associated with the instance of signal change, and firing the microfluidic ejector to dispense the fluid from the channel into a second reservoir in response to a determination that a cell is associated with the instance of signal change. In such a manner, fluid including a cell may be separated from fluid that does not include a cell. In some examples, the impedance sensor is a first impedance sensor, and the method includes dispensing the cell into the reservoir using a second impedance sensor disposed in the channel in response to confirming that the fluid includes a cell. That is, fluid samples may be confirmed to include a cell, using a second impedance sensor, prior to dispensing into a particular reservoir.

In some examples, the method includes classifying the instance of signal change as a cell instance, a multiple cell instance, a dead cell instance, a non-cell instance, or combinations thereof. In some examples, the method includes dispensing the fluid in a first reservoir in response to determining that a cell is associated with the instance of signal change and the cell is of a first type, and dispensing the fluid in a second reservoir in response to determining that a cell is associated with the instance of signal change and the cell is of a second type. Accordingly, the method may include determining that a cell is associated with the instance of signal change and determining a morphological feature of the cell.

In accordance with the present disclosure, a non-limiting example apparatus capable of control of fluid ejection from a microfluidic device, includes a foyer in fluid communication with a channel and a microfluidic ejector. In such examples, the channel is to receive fluid via the foyer and the microfluidic ejector is to expel the fluid from the channel. The example apparatus includes an impedance sensor disposed in the channel, the impedance sensor to detect an instance of signal change responsive to passage of a cell through the channel. The example apparatus includes an imaging apparatus and a controller to pause firing of the microfluidic ejector responsive to an instance of signal change detected by the impedance sensor. The controller may determine whether a cell is associated with the instance of signal change by capturing an image of the channel using the imaging apparatus.

In some examples, the imaging apparatus includes a complementary metal-oxide-semiconductor (CMOS) image sensor. In some examples, the imaging apparatus includes a camera, and a focusing lens. In some examples, the controller is to align the microfluidic ejector with a reservoir in response to a determination that a cell is associated with the instance of signal change, and resume firing of the microfluidic ejector to expel the cell in the reservoir. In some examples, the imaging apparatus includes a flat lens image array. In some examples, the controller is to determine that a cell is associated with the instance of signal change, and align the microfluidic ejector with a first reservoir in response to a determination that the cell is of a first type, and align the microfluidic ejector with a second reservoir in response to a determination that the cell is of a second type.

A non-limiting example apparatus in accordance with the present disclosure may include a non-transitory computer readable medium storing instructions that when executed cause a computing device to receive from an impedance sensor disposed in a channel of a microfluidic device, a signal indicating a change in impedance. The non-transitory computer readable medium may also store instructions that when executed, cause the computing device to control fluid ejection from a microfluidic ejector in the microfluidic device and capture an image of a channel of the microfluidic device, in response to detecting the instance of signal change from the impedance sensor disposed in the channel.

The non-transitory computer readable medium may also store instructions that when executed, cause the computing device to identify particles in the channel using a learning-based process. The non-transitory computer readable medium may store instructions that when executed, cause the computing device to fire the microfluidic ejector to eject fluid from the channel into a reservoir based on the results of the learning-based process. In some examples, the instructions to identify particles in the channel using a learning-based process include instructions that when executed cause the computing device to determine a region of interest within the captured image, count particles within the region of interest, and classify particles within the region of interest as a single cell, multiple cells, dead cells, non-cells, or combinations thereof.

In some examples, the non-transitory computer readable medium may store instructions that when executed, cause the computing device to communicate instructions to a movement control system to align the microfluidic ejector with a well plate, in response to a determination that a cell is associated with the instance of signal change. In some examples, the non-transitory computer readable medium may store instructions that when executed, cause the computing device to fire the microfluidic ejector to eject the cell into the well plate.

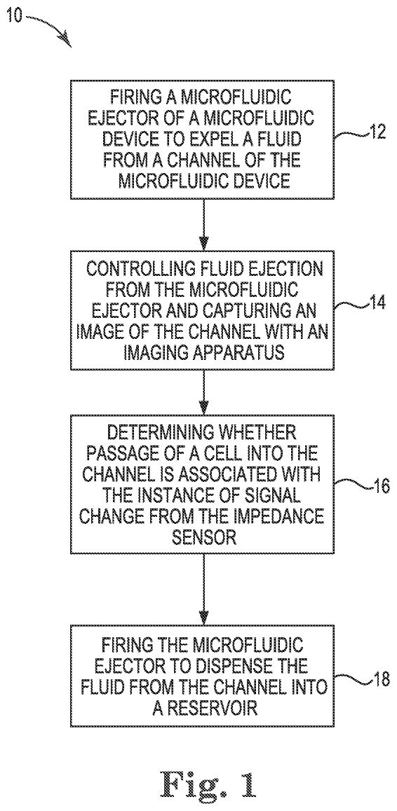

Turning now to the figures, FIG. 1 illustrates an example method 10 for control of fluid ejection from a microfluidic device, in accordance with the present disclosure.

As used herein, a microfluidic ejector refers to or includes a firing chamber to receive a fluid and expel a portion of the fluid therefrom. As used herein, the term “fluid” refers to or includes any material containing particles of interest, such as for example, foods and allied products, clinical, and environmental samples. However, the fluid referred to herein may be a biological sample, which may contain any viral or cellular material, including all prokaryotic or eukaryotic cells, viruses, bacteriophages, mycoplasmas, protoplasts, and organelles. Such biological material may thus comprise all types of mammalian and non-mammalian animal cells, plant cells, algae including blue-green algae, fungi, bacteria, protozoa, etc. Representative fluids thus include whole blood and blood-derived products such as plasma, serum and buffy coat, urine, feces, cerebrospinal fluid or any other body fluids, tissues, cell cultures, cell suspensions, etc.

As used herein, a microfluidic device refers to or includes a device including circuitry and capable of manipulation and control of small volumes of fluid through microfluidic fluidic channels. As used herein, a microfluidic channel (also referred to herein as a “channel”) refers to or includes a path through while a fluid or semi-fluid substance may pass, which has may enable transportation of volumes of fluid on the order of microliters (i.e., symbolized pL and representing units of 10 6 liter), nanoliters (i.e., symbolized nL and representing units of 10 9 liter), picoliters (i.e., symbolized pL and representing units of 10 12 liter) or femtoliters (i.e., symbolized fL and representing units of 10 15 liter).

A fluid ejector may include a plurality of components which permit fluid to be ejected therefrom. For instance, the fluid ejector may include an actuator and a nozzle in fluid communication with a channel. The actuator may be positioned in line with the nozzle. For instance, the actuator may be positioned directly above or below the nozzle. Activation of the actuator may cause some of the fluid contained in the channel to be dispensed or expelled out of the microfluidic ejector through the nozzle. In various examples, fluid may be ejected by droplet from the microfluidic ejector via a pulse of current that is passed through the actuator. Heat from the actuator may cause a rapid vaporization of the fluid in the microfluidic ejector to form a drive bubble, which causes a large pressure increase that propels a droplet of fluid out of the microfluidic ejector via the nozzle. In some examples, the microfluidic ejector can dispense fluid out of the nozzle via a piezoelectric process. In such piezoelectric processes, a voltage may be applied to the actuator in the form of a piezoelectric material. When a voltage is applied, the piezoelectric material changes shape, which generates a pressure pulse that forces a droplet of fluid from the microfluidic ejector via the nozzle. It is appreciated that other forms of microfluidic ejector can be used in accordance with the present disclosure.

As illustrated in FIG. 1, the method 10 may include at 12, firing a microfluidic ejector of a microfluidic device to expel a fluid from a channel of the microfluidic device. As discussed more thoroughly herein, a controller may activate the actuator to expel fluid contained in the channel through the nozzle of the microfluidic ejector. In some examples, the microfluidic device may expel fluid from the channel of the microfluidic device until a change in impedance is detected. For instance, the controller may supply power, e.g., AC or DC, to an impedance sensor and may detect, based upon measurements obtained by the sensor, when a particle of interest, e.g., a cell, a particular type of cell, etc., has passed through the channel. As used herein, a particle of interest refers to or includes a cell, a particular type of cell, or any other particle within a fluid that may be detected by a change of impedance. The impedance sensor may provide information, e.g., an electrical output signal representing the sensor data, to the controller.

As used herein, an impedance sensor refers to or includes a sensing material fabricated on electrodes, which is capable of measuring the change in impedance of a sensor while applying a sinusoidal voltage. Living cells are surrounded by an outer cell membrane that restricts the movement of ions and solutes between the cell interior and the exterior of the cell. Impedance sensors apply a small alternating current (AC) electrical signal to probe the value of the impedance of sensor electrodes immersed in a conductive medium. Living cells can alter the electric field between electrodes causing a change in the electrical impedance that can be detected by the sensor electrodes. The measurement of impedance by the sensor can reflect the electrophysiological state of the cell and can allow the biophysical properties of the cell to be monitored.

An impedance sensor may form an electric field region within microfluidic channels of the microfluidic device. The impedance sensor may include a local electrical ground and an electrode which cooperate to form a region of electric field lines that extend within the microfluidic channel. When a cell passes through the electric field region, the electric field lines of the region are at least partially obstructed by the cell such that the electric field lines of the region are altered and travel around the cell. The increased length of the electric field lines, resulting from having to travel around the cell, increases or raises the electrical impedance that may be detected at the electrode. As a result, the increase in impedance resulting from obstruction of the electric field region by the cell serves as an indicator of one or more characteristics of the cell, such as the size of the cell.

At 14, the method 10 includes, in response to detecting an instance of signal change from an impedance sensor disposed in the channel, controlling fluid ejection from the microfluidic ejector and capturing an image of the channel with an imaging apparatus. When cells are being ejected from the microfluidic ejector, they will pass an impedance sensor and cause the impedance sensor output to increase, therefore forming a peak in the sensor signal. The impedance sensor may measure the impedance signal at a higher rate than the firing frequency of the microfluidic ejector. The controller may analyze the signals received from the impedance sensor in real-time or near-real-time and control fluid ejection from the microfluidic ejector, accordingly. The controller may also control operation of an imaging apparatus based on a change in impedance received from the impedance sensor. The characteristics of the change in impedance can also be used to recognize the type of cell and/or particle of interest.

As used herein, an imaging apparatus refers to or includes a device capable of capturing an image of microscopic particles within the fluid. The imaging apparatus may comprise a portion of the microfluidic device, or may be a separate component used in collaboration with the microfluidic device.

At 16, the method 10 includes using the captured image, determining whether passage of a cell into the channel is associated with the instance of signal change from the impedance sensor. For instance, once a change in impedance is measured by impedance sensor, the impedance sensor may communicate the impedance measurement to the controller to control fluid ejection from the microfluidic ejector and pause the flow of fluid through the microfluidic ejector. Milliseconds may pass between the measurement of a change of impedance and the pause of fluid flow through the microfluidic ejector, so that the cell(s) may stay in the channel of the microfluidic device for examination by the imaging apparatus.

As a non-limiting example, the method 10 may include classifying the instance of signal change as a cell instance, a multiple cell instance, a dead cell instance, a non-cell instance, or combinations thereof. As used herein, a “cell instance” refers to or includes a change in impedance that is determined by the controller as being associated with a cell. In some instances, the controller may identify a type of cell based on the impedance measurement. Also, a “multiple cell instance” refers to or includes a change in impedance that is determined by the controller as being associated with a plurality of cells passing the impedance sensor at a same time (such as cells aggregated together). A “dead cell instance” refers to or includes a change in impedance that is determined by the controller as being associated with a cell that is not living, such as a cell without an intact cellular membrane, and/or a cell with a nucleus that has undergone disintegration. A “non-cell instance” refers to or includes a change in impedance that is determined by the controller as being associated with a particle other than a cell, such as cellular debris. As such, based on the impedance signal measured by the impedance sensor, the microfluidic device may determine whether a cell is disposed within the channel of the microfluidic device, whether multiple cells are disposed within the channel of the microfluidic device, whether particulate matter was detected within the channel of the microfluidic device, and/or if a non-cell event was detected.

The controller may execute various instructions to find cells and/or particles of interest within the fluid. For instance, detection or segmentation operations may be used for finding cells. Non-limiting examples of imaging modalities that may be used include brightfield, fluorescent, and phase-contrast. Depending on the imaging modality or imaging modalities used, different instructions may be executed for finding cells and/or particles of interest within the fluid. For images with complex background such as brightfield, phase-contrast, and non-uniform fluorescence, learning-based approaches may outperform other image processing methods.

A learning-based process may also be referred to herein as a machine-learning model. Two types of learning-based approaches may be used to count and/or identify cells or particles of interest within the fluid: segmentation and detection. In a segmentation method, pixels may be classified and a label image may be generated where different types of cells have different labels, such as different intensity or color. In a detection method, the location of cells (or other particles of interest) may be identified and bounding boxes outside individual cells may be reported. If multiple types of cells (or other particles of interest) are identified, the cell type for each detected cell may also be reported.

At 18, the method 10 includes firing the microfluidic ejector to dispense the fluid from the channel into a reservoir, based on the determination. In such a manner, cells may be sorted and/or dispensed into respective reservoirs, such as for growth of monoclonal cell lines. As used herein, a reservoir refers to or includes an apparatus capable of storing and/or containing a volume. Non-limiting examples of a reservoir include a well of a microwell plate, a test tube, a centrifuge tube, a spot of a spot plate, among others.

The controller may activate the actuator of the microfluidic ejector a predefined number of times to expel the cell or other particle of interest from the channel. The predefined number of times may correspond to the number of times that the actuator is to be activated in order to expel most or all of the fluid contained in the channel following detection of the cell or other particle of interest. That is, for instance, the predefined number of times may correspond to the number of times that the actuator is to be activated in order to cause the cell or other particle of interest contained in the channel to be expelled.

For instance, in response to the determination of whether a cell has passed into the channel, different actions may be taken. In some examples, the method 10 includes firing the microfluidic ejector to dispense the fluid from the channel into a first reservoir in response to a determination that a cell is not associated with the instance of signal change, and firing the microfluidic ejector to dispense the fluid from the channel into a second reservoir in response to a determination that a cell is associated with the instance of signal change. In such a manner, individual cells may be dispensed into particular locations, whereas carrier fluid may be dispensed into a different location or different locations. Additionally, individual cells may be dispensed into a particular location responsive to confirmation that a cell is disposed in the channel. For instance, in some examples, the impedance sensor is a first impedance sensor, and the method 10 includes dispensing the cell into the reservoir in response to confirming, using a second impedance sensor disposed in the channel, that the fluid includes a cell.

As another non-limiting example, the method 10 may include sorting cells within the microfluidic device based on a cell type. In such examples, cells of a first type may be dispensed into a first reservoir, and cells of a second type may be dispensed into a second reservoir. For instance, the method 10 may include dispensing the fluid in a first reservoir in response to determining that a cell is associated with the instance of signal change and the cell is of a first type, and dispensing the fluid in a second reservoir in response to determining that a cell is associated with the instance of signal change and the cell is of a second type. As an illustration, cells may be sorted into different reservoirs based in part on a morphological feature of a cell detected in the microfluidic device. As such, the method 10 may include determining that a cell is associated with the instance of signal change and determining a morphological feature of the cell.

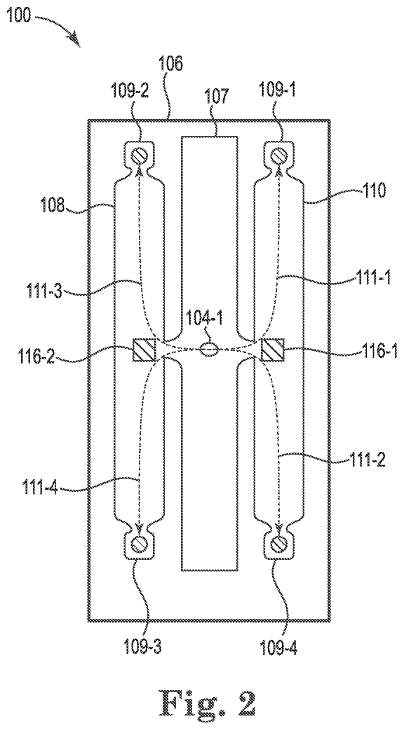

FIG. 2 illustrates an example apparatus 100, in accordance with the present disclosure. In general, the apparatus 100 shown in FIG. 2 may include various components that are the same and/or substantially similar to components discussed with regards to in FIG. 1, which was described in greater detail above. As such, for brevity and ease of description, various details relating to certain components in the apparatus 100 shown in FIG. 2 may be omitted herein to the extent that the same or similar details have already been provided above in relation to the microfluidic device discussed in regards to FIG. 1. As such, the apparatus 100 shown in FIG. 2 may be capable of performing the method 10 illustrated in FIG. 1.

The apparatus 100 illustrated in FIG. 2 may be referred to as a microfluidic device, and/or may comprise a portion of a microfluidic device. The microfluidic device 100 may be formed of a structural component, such as silicon, a polymeric material, an epoxy-based negative photoresist (such as SU-8), or the like. The structural component may be formed through implementation of microfabrication techniques such as electroforming, laser ablation, anisotropic etching, sputtering, dry and wet etching, photolithography, casting, molding, stamping, machining, spin coating, laminating, and the like.

As illustrated in FIG. 2, the apparatus 100 may include various components. For instance, the apparatus 100 may include a channel such as channels 108 and 110 in fluid communication with a foyer 107 and a microfluidic ejector such as microfluidic ejectors 109-1, 109-2, 109-3, and 109-4. Although the channels 108 and 110 have been depicted as having a linear configuration, the channels 108 and 110 may include other shapes, such as a curved shape, a snake-like shape, a shape with corners, combinations thereof, or the like. As used herein, a foyer refers to or includes a manifold, a fluid slot, or fluid hole array to receive fluid from a source and supply the fluid to channels 108 and 110. In various examples, the channel (such as 108 and 110) is to receive fluid via the foyer 107 and the microfluidic ejector (such as microfluidic ejectors 109-1, 109-2, 109-3, and 109-4, referred to collectively as microfluidic ejectors 109) is to expel the fluid from the channel 108, 110. In such a manner, fluid including cells may travel through the foyer 107, into the channels 108 and 110 as indicated by the dashed lines, and out of each respective microfluidic ejector 109-1, 109-2, 109-3, and 109-4 as indicated in the dashed lines.

FIG. 2 provides simplified illustrations of microfluidic ejectors 109. However, as discussed with regards to FIG. 1, each microfluidic ejector may include a plurality of components, including an actuator and a nozzle. In general, the structures and components of the microfluidic ejectors 109 may be fabricated using integrated circuit microfabrication techniques such as electroforming, laser ablation, anisotropic etching, sputtering, dry and wet etching, photolithography, casting, molding, stamping, machining, spin coating, laminating, and the like. Also, although the apparatus 100 illustrated in FIG. 2 illustrates two channels, each with two microfluidic ejectors, the apparatus 100 may include more or fewer channels than illustrated and more or fewer microfluidic ejectors than illustrated.

The apparatus 100 may also include an impedance sensor, such as impedance sensors 116-1 and 116-2 (collectively referred to as impedance sensors 116) disposed in the channel. For instance, impedance sensor 116-1 may be disposed in channel 110 and impedance sensor 116-2 may be disposed in channel 108. As discussed herein, the impedance sensors 116-1 and 116-2 may detect an instance of signal change responsive to passage of a cell through the channel (108 or 110). The components of the impedance sensor or impedance sensors 116 may be formed into the structural component through integrated circuit fabrication techniques. In addition, the channel or channels (108 and/or 110) and components of the microfluidic ejector or microfluidic ejectors 109 may be formed through the structural component, for instance, by etching.

As illustrated by the dashed lines, microfluidic ejectors 109-1, 109-2, 109-3, and 109-4 can each dispense fluid which may result in the cell 104-1 travelling through the respective channel and out of the microfluidic ejector in the direction of the dashed line. For instance, microfluidic ejector 109-1 may dispense fluid so as to move cell 104-1 through channel 110 along path 111-1 and out of microfluidic ejector 109-1. Similarly, microfluidic ejector 109-4 may dispense fluid so as to move cell 104-1 through channel 110 along path 111-2 and out of microfluidic ejector 109-4. As another example, microfluidic ejector 109-2 may dispense fluid so as to move cell 104-1 through channel 108 along path 111-3 and out of microfluidic ejector 109-2. Yet further, microfluidic ejector 109-3 may dispense fluid so as to move cell 104-1 through channel 108 along path 111-4 and out of microfluidic ejector 109-3. Although various examples herein illustrate an apparatus 100 including four microfluidic ejectors, examples are not so limited.

Although not illustrated in FIG. 2, the apparatus 100 may include an imaging apparatus to capture an image of the cell 104-1. For instance, the imaging apparatus may include a machine vision system with illumination, magnification, a camera, or combinations thereof. As another non-limiting example, the imaging apparatus may include a lensless image array, which includes illumination, an image sensor, reconstruction instructions, or combinations thereof. As another non-limiting example, the imaging apparatus may include a flat lens image array, which includes with illumination, magnification, a plurality of micro scale lenses, or combinations thereof. As described with reference to FIG. 1, a controller may control fluid ejection from the microfluidic device 100 so as to pause or stop the dispense flow and hold the cell 104-1 in the channel for an amount of time (such as a few seconds), then resume the flow by firing (also referred to as “actuating”) the microfluidic ejector or microfluidic ejectors 109. The image, captured by the imaging apparatus, may be used by the controller to detect the existence of cells (or other particles of interest), reports the number of detected cells (or other particles of interest), and identifies the cell type(s) and/or types of other particles of interest.

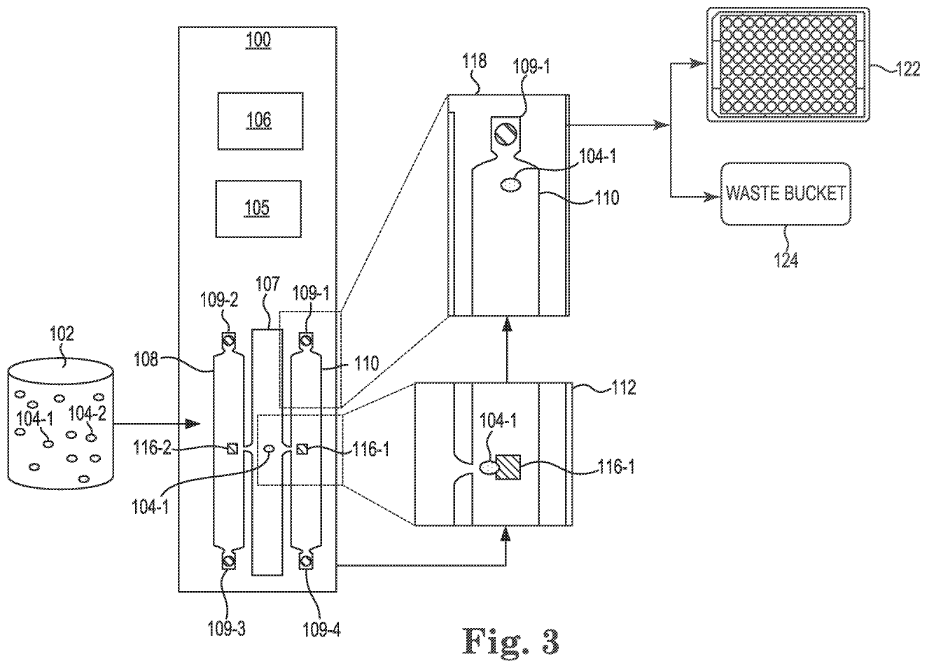

FIG. 3 is a flow diagram illustrating an example method for control of fluid ejection from a microfluidic device (such as apparatus 100), in accordance with the present disclosure. In general, the method shown in FIG. 3 may be performed by various components that are the same and/or substantially similar to components discussed with regards to in FIG. 1 and/or FIG. 2, which was described in greater detail above. As such, for brevity and ease of description, various details relating to certain components in the method 10 shown in FIG. 1, and apparatus 100 shown in FIG. 2, may be omitted herein to the extent that the same or similar details have already been provided above in relation to the microfluidic device discussed in regards to FIG. 1 and FIG. 2.

As illustrated in FIG. 3, a cell solution 102 including a plurality of cells 104-1 and 104-2 (collectively referred to herein as cells 104) may be fed into the foyer 107. As discussed with regards to FIG. 2, cells may pass from the foyer 107 into each channel 108 and 110. As a cell passes from the foyer 107 into the channel 108 or 110, an impedance sensor may detect passage of the cell. For instance, as illustrated in expanded box 112, the cell may pass over impedance sensor 116-1, and a change of impedance may be measured.

In some examples, the apparatus 100 includes an imaging apparatus 105, and a controller 106 to pause firing of the microfluidic ejector 109-1, 109-2, 109-3, and/or 109-4 responsive to an instance of signal change detected by the impedance sensor. For instance, responsive to impedance sensor 116-1 detecting cell 104-1, microfluidic ejectors 109-1 and 109-4 may pause firing so as to stop the movement of cell 104-1 in the channel 110. The controller 106 may determine whether a cell is associated with the instance of signal change by capturing an image of the channel using the imaging apparatus 105.

The controller 106 may be a computing device, a semiconductor-based microprocessor, a central processing unit (CPU), an application specific integrated circuit (ASIC), a programmable logic device (PLD), and/or other hardware device. The controller 106 may also receive power from a power source or a power supply (not shown). The controller 106 may be communicatively coupled to a non-transitory machine readable medium (not illustrated in FIG. 3), such as Random Access Memory (RAM), an Electrically Erasable Programmable Read-Only Memory (EEPROM), a storage device, an optical disc, or the like.

The imaging apparatus 105 can include machine vision system with illumination, magnification, a camera, or combinations thereof. Similarly, the imaging apparatus 105 can include a lensless image array, which includes illumination, an image sensor, a reconstruction algorithm, or combinations thereof. Non-limiting examples of image sensors that may be used include a complementary metal-oxide-semiconductor (CMOS) micro camera module, an ultra-low-power CMOS image sensor, and/or a lensless image array, among others. As such, the apparatus 100 may include an imaging apparatus 105, wherein the imaging apparatus includes a complementary metal-oxide-semiconductor (CMOS) image sensor. Examples are not so limited, and the imaging apparatus 105 may include a camera, and a focusing lens. The imaging apparatus 105 may be a part of the microfluidic device 100, and/or the imaging apparatus 105 may be separate and distinct from the microfluidic device 100.

The controller 106 may control fluid ejection from the microfluidic device 100, such that fluid from channel 108 and/or channel 110 is dispensed into a particular reservoir. For instance, the controller 106 may control fluid ejection from the microfluidic device 100 to eject the cell 104-1 into a microwell plate 122, to eject fluid into the waste bucket 124, and/or to eject the cell into the waste bucket 124. In such a manner, the cells 104 included in the cell solution 102 may be identified by the controller 106, imaged by the imaging apparatus 105, and dispensed into a particular well in microwell plate 122 or into waste bucket 124.

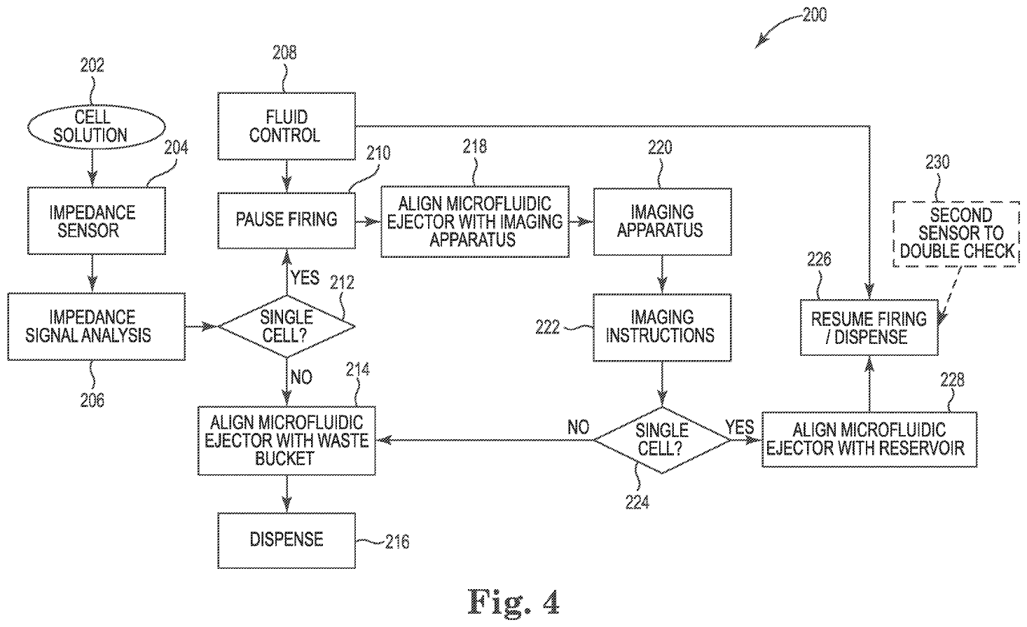

FIG. 4 is a block diagram illustrating an example method 200 for control of fluid ejection from a microfluidic device (such as apparatus 100), in accordance with the present disclosure. In general, the method shown in FIG. 4 may be performed by various components that are the same and/or substantially similar to components discussed with regards to in FIG. 1, FIG. 2, and/or FIG. 3, which were described in greater detail above. As such, for brevity and ease of description, various details relating to certain components in the method 10 shown in FIG. 1, apparatus 100 shown in FIG. 2, and the method shown in FIG. 3 may be omitted herein to the extent that the same or similar details have already been provided above in relation to the microfluidic device discussed in regards to FIG. 1, FIG. 2, and FIG. 3. As such, the method shown in FIG. 4 may be performed by the apparatus 100 illustrated in FIG. 2 and in FIG. 3.

At 202, the cell solution is fed into the microfluidic device, and at 204 an impedance sensor detects a change in impedance. At 206, the method 200 proceeds to impedance signal analysis. When cells are being printed/dispensed, they will pass an electric impedance sensor, such as impedance sensor 116-1 or impedance sensor 116-2, and causes the sensor output to increase, therefore forming a peak in the sensor signal. The impedance sensor (116-1 and 116-2) may measure the impedance signal continuously at a higher rate than the firing frequency of the microfluidic ejectors (109). A controller may execute instructions to analyze the impedance signal in real-time or near-real-time and detect a change in impedance. The change in impedance which initiates a change in the control of the microfluidic ejector may exceed a threshold change in impedance. For instance, if the impedance increases by more than a threshold amount, the controller may modulate control of the microfluidic ejector so that an image of the foyer (107) and/or the channel (108 and/or 110) may be captured. The characteristics of the peak may also be used by the controller to recognize the event type, such as a dead cell instance, a non-cell instance, a multiple cell instance, etc.

At 212, the method 200 includes determining if a single cell was associated with the change in impedance. If the change in impedance was not associated with a single cell, the method 200 proceeds to 214. At 214, the controller may align the microfluidic ejector with a waste bucket for disposal of the fluid sample that does not include a single cell. At 216, the fluid is dispensed into the waste bucket.

If, at 212 the controller identifies that the change in impedance is associated with a single cell, then the method 200 continues at 210. At 210, the method 200 includes pausing firing. As discussed herein, the controller (such as controller 106 illustrated in FIG. 3) may pause firing of the microfluidic ejector (or microfluidic ejectors, as the case may be), to pause the flow of fluid through the channel. For instance, referring again to FIG. 3, if the apparatus (100) included one channel (such as 110) and not two channels (108 and 110), the controller (106) may pause firing of microfluidic ejectors (such as 109-1 and 109-4) to pause the flow of fluid through the channel (110). In such a manner, the controller may perform fluid control at 208 while also pausing firing at 210.

At 218, the method 200 includes aligning the microfluidic ejector with the imaging apparatus. In various examples, the apparatus may include or be coupled to, a movement control system. The movement control system may align the microfluidic ejector with the imaging apparatus, and with various reservoirs (such as a well plate, a waste bucket, etc.). For example, the movement control system may retain the microfluidic ejector in a stationary position, whereas the imaging apparatus and the reservoir(s) move relative to the microfluidic ejector for dispensing. As another example, the reservoir(s) and the imaging apparatus may remain stationary, and the microfluidic ejector may move to align with the reservoir and/or imaging apparatus. In any event, at 218 the microfluidic ejector may be aligned with the imaging apparatus such that an image of the channel and/or foyer of the microfluidic device may be captured.

At 220, the method 200 includes the imaging apparatus capturing an image or a plurality of images of the fluid in the microfluidic device. The imaging apparatus may capture images of the channel, of a plurality of channels within the microfluidic device, and/or of the foyer.

At 222, the method 200 includes the controller executing imaging instructions, to classify the instance of signal change as a cell instance, a multiple cell instance, a dead cell instance, a non-cell instance, or combinations thereof. Various different imaging instructions may be executed. For instance, label-free cell imaging instructions may be executed, in which unstructured data is converted to semi-structured data and structured data. When converting the unstructured data to semi-structured data, an image of the fluid within the microfluidic device is preprocessed. During preprocessing, a region of interest is identified which appears to include particles. Next, cells are found within the region of interest using a deep learning model. The result of the deep learning model results in semi-structured data comprising images of suspected cells. Next, postprocessing may generate a cell mask image which allows for the counting of cells. From the counting of cells, structured data may be generated in the form of numbers which classify the signal change as a multiple cell instance, a dead cell instance, a non-cell instance, or combinations thereof. A non-limiting example of a deep learning model that may be used includes U-Net, as described in “U-Net: Convolutional Networks for Biomedical Image Segmentation,” Olaf Ronneberger, Philipp Fischer, Thomas Brox, Medical Image Computing and Computer-Assisted Intervention (MICCAI), Springer, LNCS, Vol. 9351:234-241, 2015, which is herein incorporated in entirety for the teachings related to label-free cell imaging. An additional non-limiting example of a deep learning model that may be used includes Mask R-CNN, as described in K. He, G. Gkioxari, P. Dollar and R. Girshick, “Mask R-CNN,” 2017 IEEE International Conference on Computer Vision (ICCV), 2017, pp. 2980-2988, doi: 10.1109/ICCV.2017.322, which is herein incorporated in entirety for the teachings related to label-free cell imaging.

At 224, the method 200 includes determining from the execution of the imaging instructions, whether the change in impedance was associated with a single cell. If not, the method 200 proceeds back to 214 with aligning the microfluidic ejector with the waste bucket and dispensing the fluid at 216. If at 224 the execution of the imaging instructions results in a determination that the change in impedance was associated with a single cell, then the method 200 proceeds at 228 to aligning the microfluidic ejector with a reservoir, such as with a well in a microwell plate. As indicated in FIG. 4, the fluid may be dispensed by the microfluidic ejector resuming firing at 226.

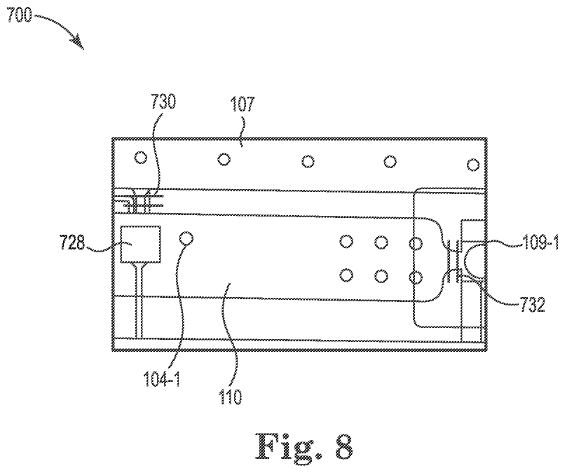

In some examples, as indicated at 230, a second impedance sensor may confirm the presence of the cell or other particle of interest in the channel before dispensing into the reservoir. A second impedance sensor is discussed with regards to FIG. 8.

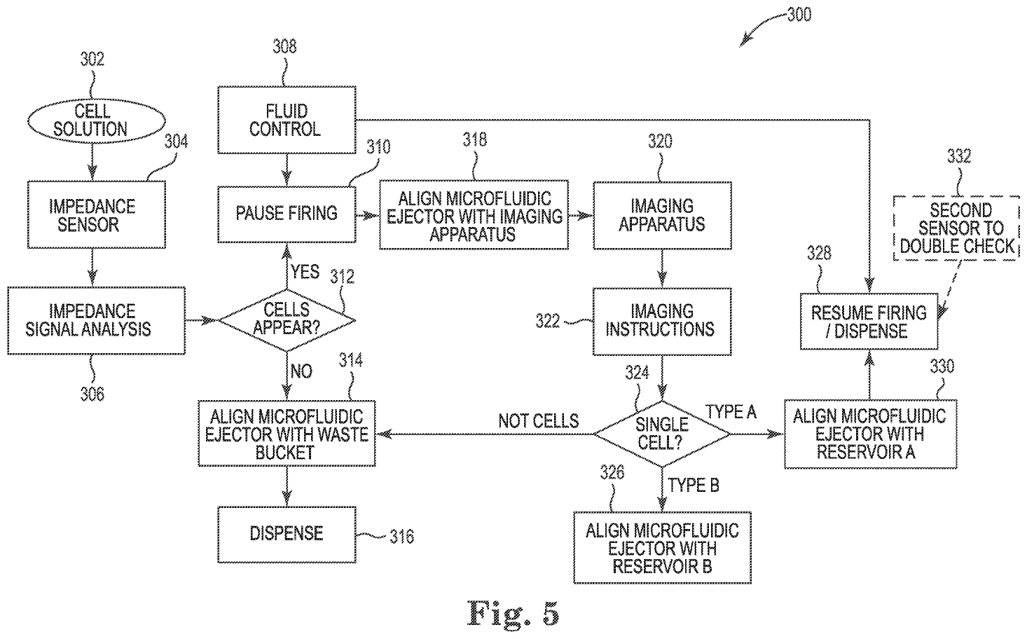

FIG. 5 is a block diagram illustrating an example method 300 for sorting of cells by cell type via control of fluid ejection from a microfluidic device (such as apparatus 100), in accordance with the present disclosure. In general, the method shown in FIG. 5 may be performed by various components that are the same and/or substantially similar to components discussed with regards to in FIG. 1, FIG. 2, and/or FIG. 3, which were described in greater detail above. As such, for brevity and ease of description, various details relating to certain components in the method 10 shown in FIG. 1, apparatus 100 shown in FIG. 2, and the method shown in FIG. 3 may be omitted herein to the extent that the same or similar details have already been provided above in relation to the microfluidic device discussed in regards to FIG. 1, FIG. 2, and FIG. 3. As such, the method shown in FIG. 5 may be performed by the apparatus 100 illustrated in FIG. 2 and in FIG. 3.

At 302, the cell solution is fed into the microfluidic device, and at 304 an impedance sensor detects a change in impedance. At 306, the method 300 proceeds to impedance signal analysis. When cells are being printed/dispensed, they will pass an electric impedance sensor, such as impedance sensor 116-1 or impedance sensor 116-2, and causes the sensor output to increase, therefore forming a peak in the sensor signal. The impedance sensor (116-1 and 116-2) may measure the impedance signal continuously at a higher rate than the firing frequency of the microfluidic ejectors (109). A controller may execute instructions to analyze the impedance signal in real-time or near-real-time and detect a change in impedance. The change in impedance which initiates a change in the control of the microfluidic ejector may exceed a threshold change in impedance. For instance, if the impedance increases by more than a threshold amount, the controller may modulate control of the microfluidic ejector so that an image of the foyer (107) and/or the channel (108 and/or 110) may be captured. The characteristics of the peak may also be used by the controller to recognize the event type, such as a dead cell instance, a non-cell instance, a multiple cell instance, etc.

At 312, the method 300 includes determining if a single cell was associated with the change in impedance. If the change in impedance was not associated with a single cell, the method 300 proceeds to 314. At 314, the controller may align the microfluidic ejector with a waste bucket for disposal of the fluid sample that does not include a single cell. At 316, the fluid is dispensed into the waste bucket.

If, at 312 the controller identifies that the change in impedance is associated with a single cell, then the method 300 continues at 310. At 310, the method 300 includes pausing firing. As discussed herein, the controller (such as controller 106 illustrated in FIG. 3) may pause firing of the microfluidic ejector (or microfluidic ejectors, as the case may be), to pause the flow of fluid through the channel. For instance, referring again to FIG. 3, if the apparatus (100) included one channel (such as 110) and not two channels (108 and 110), the controller (106) may pause firing of microfluidic ejectors (such as 109-1 and 109-4) to pause the flow of fluid through the channel (110). In such a manner, the controller may perform fluid control at 308 while also pausing firing at 310.

At 318, the method 300 includes aligning the microfluidic ejector with the imaging apparatus. In various examples, the apparatus may include or be coupled to, a movement control system. The movement control system may align the microfluidic ejector with the imaging apparatus, and with various reservoirs (such as a well plate, a waste bucket, etc.). For example, the movement control system may retain the microfluidic ejector in a stationary position, whereas the imaging apparatus and the reservoir(s) move relative to the microfluidic ejector for dispensing. As another example, the reservoir(s) and the imaging apparatus may remain stationary, and the microfluidic ejector may move to align with the reservoir and/or imaging apparatus. In any event, at 318 the microfluidic ejector may be aligned with the imaging apparatus such that an image of the channel and/or foyer of the microfluidic device may be captured. In various examples, the movement control system may include a motor or other actuator to move respective components. The movement control system may be communicatively coupled with a controller, which may control the motor or other actuator.

At 320, the method 300 includes the imaging apparatus capturing an image or a plurality of images of the fluid in the microfluidic device. The imaging apparatus may capture images of the channel, of a plurality of channels within the microfluidic device, and/or of the foyer.

At 322, the method 300 includes the controller executing imaging instructions, to classify the instance of signal change as a cell instance, a multiple cell instance, a dead cell instance, a non-cell instance, or combinations thereof. Various different imaging instructions may be executed. For instance, label-free cell imaging instructions may be executed, in which unstructured data is converted to semi-structured data and structured data. When converting the unstructured data to semi-structured data, an image of the fluid within the microfluidic device is preprocessed. During preprocessing, a region of interest is identified which appears to include particles. Next, cells are found within the region of interest using a deep learning model. The result of the deep learning model results in semi-structured data comprising images of suspected cells. Next, postprocessing may generate a cell mask image which allows for the counting of cells. From the counting of cells, structured data may be generated in the form of numbers which classify the signal change as a multiple cell instance, a dead cell instance, a non-cell instance, or combinations thereof. A non-limiting example of a deep learning model that may be used includes U-Net, as described in “U-Net: Convolutional Networks for Biomedical Image Segmentation,” Olaf Ronneberger, Philipp Fischer, Thomas Brox, Medical Image Computing and Computer-Assisted Intervention (MICCAI), Springer, LNCS, Vol. 9351:234-241, 2015, which is herein incorporated in entirety for the teachings related to label-free cell imaging. An additional non-limiting example of a deep learning model that may be used includes Mask R-CNN, as described in K. He, G. Gkioxari, P. Dollár and R. Girshick, “Mask R-CNN,” 2017 IEEE International Conference on Computer Vision (ICCV), 2017, pp. 2980-2988, doi: 10.1109/ICCV.2017.322, which is herein incorporated in entirety for the teachings related to label-free cell imaging. Using the deep learning model, different types of cells may be identified, such that cells may be sorted by type.

At 324, the method 300 includes determining from the execution of the imaging instructions, whether the change in impedance was associated with cells. If execution of the imaging instructions results in a determination that the change in impedance was not associated with a cell, the method 300 proceeds back to 314 with aligning the microfluidic ejector with the waste bucket and dispensing the fluid at 316. If at 324 the execution of the imaging instructions results in a determination that the change in impedance was associated with a cell, then the method 300 proceeds at 326 to aligning the microfluidic ejector with a first reservoir to dispense cells or other particles of interest of one type (such as “type B”) into one reservoir (such as “reservoir B”) and at 330 aligning the microfluidic ejector with a second reservoir to dispense cells or other particles of interest of another type (such as “type A”) into the second reservoir (such as “reservoir A”). As indicated in FIG. 5, the fluid may be dispensed by the microfluidic ejector resuming firing at 328.

In some examples, as indicated at 332, a second impedance sensor may confirm the presence of the cell or other particle of interest in the channel before dispensing into the reservoir. A second impedance sensor is discussed with regards to FIG. 8.

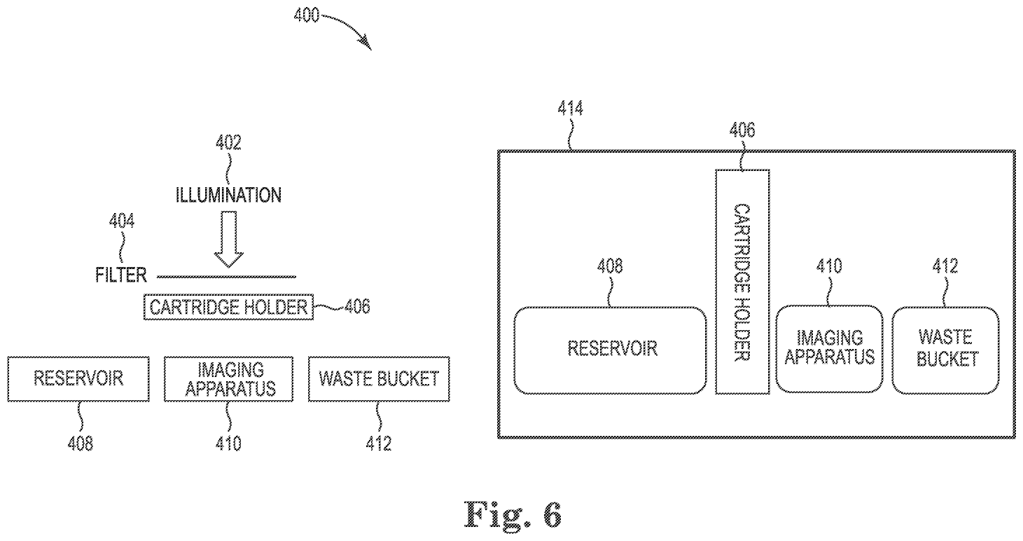

FIG. 6 illustrates an example system 400 for control of fluid ejection from a microfluidic device, in accordance with the present disclosure. In general, the system 400 shown in FIG. 6 may include various components that are the same and/or substantially similar to components discussed with regards to in FIG. 1, FIG. 2, and/or FIG. 3 which were described in greater detail above. As such, for brevity and ease of description, various details relating to certain components discussed with regards to FIG. 1, FIG. 2, and/or FIG. 3 may be omitted herein to the extent that the same or similar details have already been provided above.

The left half of FIG. 6 illustrates a side view of the system 400, whereas box 414 illustrates a top-down view of the system 400. As illustrated in FIG. 6, the system 400 may include an illumination source 402, a filter 404, a cartridge holder 406, a well plate or container (e.g., a reservoir) 408, an imaging apparatus 410, and a waste bucket 412. As used herein, a carriage holder refers to or includes a moveable supporting structure that holds the microfluidic device (100 illustrated in FIG. 2). In some examples, the system 400 may include the microfluidic device without a cartridge holder. Similarly, the imaging apparatus 410 may include an optical microscope and a camera, whereas the illumination source 420 and filter 404 are optional. The system 400 may be used to perform, bright field, dark field, fluorescence, hyperspectral, and other imaging modalities.

As illustrated in box 414, the system 400 may operate in different ways to align the microfluidic ejector with the reservoir(s) and/or imaging apparatus. For instance, in some examples the cartridge holder 406 may move to the left and/or right, up and/or down, over the reservoir 408, the imaging apparatus 410, or the waste bucket 412, as discussed herein. In another example, the cartridge holder 406 may stay stationary while the reservoir 408, the imaging apparatus 410, or the waste bucket 412, move left and/or right, up and/or down, beneath the cartridge holder.

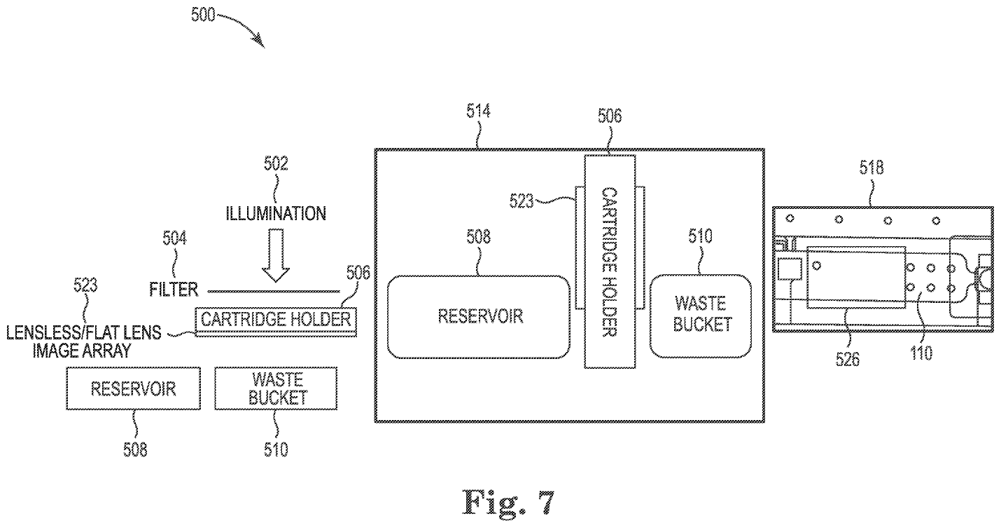

FIG. 7 illustrates an example system 500 for control of fluid ejection from a microfluidic device, in accordance with the present disclosure. In general, the system 500 shown in FIG. 7 may include various components that are the same and/or substantially similar to components discussed with regards to in FIG. 1, FIG. 2, and/or FIG. 3 which were described in greater detail above. As such, for brevity and ease of description, various details relating to certain components discussed with regards to FIG. 1, FIG. 2, and/or FIG. 3 may be omitted herein to the extent that the same or similar details have already been provided above.

Similar to FIG. 6, the left half of FIG. 7 illustrates a side view of the system 500, box 514 illustrates a top-down view of system 500, and box 518 illustrates an image of the microfluidic device as discussed herein. As illustrated in FIG. 7, the system 500 may include an illumination source 502, a filter 504, a cartridge holder 506 with a lensless or flat lens image array 523, a reservoir 508, and a waste bucket 510. In some examples, the system 500 may include the microfluidic device without a cartridge holder. Similarly, the illumination source 502 and filter 504 are optional. The system 500 may be used to perform, bright field, dark field, fluorescence, hyperspectral, and other imaging modalities.

As illustrated in box 514, the system 500 may operate in different ways to align the microfluidic ejector with the reservoir(s). For instance, in some examples the cartridge holder 506 may move to the left and/or right, up and/or down, over the reservoir 508, or the waste bucket 510, as discussed herein. In another example, the cartridge holder 506 may stay stationary while the reservoir 508, the or the waste bucket 510, move left and/or right, up and/or down, beneath the cartridge holder.

The lensless or flat lens image array 523 may be disposed on the cartridge holder in such a manner that the microfluidic ejector(s) of the microfluidic device are not obstructed by the lensless or flat lens image array 523. More particularly, the lensless or flat lens image array 523 may be disposed over a region of interest 526 in the microfluidic device, as illustrated in box 518. As used herein, a region of interest refers to or includes an area of the microfluidic device, such as a portion of a channel, a portion of a plurality of channels, the foyer, or combinations thereof, within which deep learning will be performed to identify particles of interest, such as cells.

FIG. 8 illustrates a portion of an example apparatus 700 including multiple impedance sensors, in accordance with the present disclosure. The portion illustrated in FIG. 8 illustrates channel 110, and foyer 107 and microfluidic ejector 109-1. As described herein, an impedance sensor may detect passage of a particle of interest, such as cell 104-1, from the foyer 107 into the channel 110. For instance, a first impedance sensor comprising electrodes 730 and 728 may detect passage of cell 104-1 from the foyer 107 into the channel 110. Once the change in impedance is detected in by the impedance sensor, the controller may control fluid ejection from the microfluidic device to pause the flow of fluid as described herein. This may happen in milliseconds so that the cell 104-1 (or plurality of cells) stop and stay in the channel 110 for examination via execution of the imaging instructions.

While the flow of fluid is paused, the movement control system may align the imaging apparatus so that the channel 110 is in the field of view of the imaging apparatus. The imaging apparatus may take an image of the channel 110, and send the captured image to the controller for execution of the imaging instructions. As described herein, the imaging instructions may classify the instance of impedance signal change as a cell instance, a multiple cell instance, a dead cell instance, a non-cell instance, or combinations thereof.

A second impedance sensor comprising electrodes 732 may be disposed in close proximity to the microfluidic ejector 109-1. The second impedance sensor may measure a change in impedance as fluid is ejected out of microfluidic ejector 109-1, and a change in impedance signal detected at electrodes 732 may verify the presence of a cell or other particle of interest being dispensed from the microfluidic ejector 109-1.

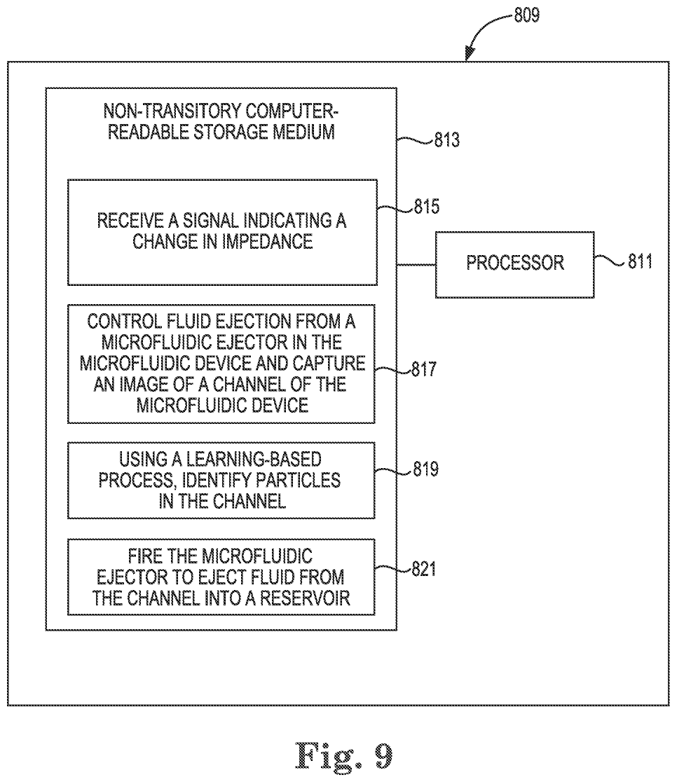

FIG. 9 illustrates an example computing device 809 for control of fluid ejection from a microfluidic device, in accordance with the present disclosure. As illustrated in FIG. 9, the computing device 809 may include a processor 811, and a computer-readable storage medium 813. The computing device 809 may perform the methods illustrated and described with regards to FIG. 1, FIG. 2, FIG. 3, FIG. 4, FIG. 5, FIG. 6, FIG. 7, and FIG. 8. In various examples, the computing device 809 may comprise the controller 106 described with reference to FIG. 3

The processor 811 may be a central processing unit (CPU), a semiconductor-based microprocessor, and/or other hardware device suitable to control operations of the computing device 809. Computer-readable storage medium 813 may be an electronic, magnetic, optical, or other physical storage device that contains or stores executable instructions. Thus, computer-readable storage medium 813 may be, for example, Random Access Memory (RAM), an Electrically Erasable Programmable Read-Only Memory (EEPROM), a storage device, an optical disc, etc. In some examples, the computer-readable storage medium 813 may be a non-transitory storage medium, where the term ‘non-transitory’ does not encompass transitory propagating signals. As described in detail below, the computer-readable storage medium 813 may be encoded with a series of executable instructions 815-821.

In some examples, computer-readable storage medium 813 includes instructions 815 that when executed, cause the computing device 809 to receive from an impedance sensor disposed in a channel of a microfluidic device, a signal indicating a change in impedance. The computer-readable storage medium 813 further include instructions 817 that when executed, cause the computing device 809 to in response to detecting the instance of signal change from the impedance sensor disposed in the channel, control fluid ejection from a microfluidic ejector in the microfluidic device and capture an image of a channel of the microfluidic device. The computer-readable storage medium 813 further include instructions 819 that when executed, cause the computing device 809 to, using a learning-based process, identify particles in the channel.

The computer-readable storage medium 813 further include instructions 821 that when executed, cause the computing device 809 to, based on the results of the learning-based process, fire the microfluidic ejector to eject fluid from the channel into a reservoir.

In some examples, the instructions 819 to identify particles in the channel using a learning-based process include instructions that when executed cause the computing device to determine a region of interest within the captured image, count particles within the region of interest, and classify particles within the region of interest as a single cell, multiple cells, dead cells, non-cells, or combinations thereof.

In some examples, the computer-readable storage medium 813, includes instructions that when executed cause the computing device 809 to in response to a determination that a cell is associated with the instance of signal change, communicate instructions to a movement control system to align the microfluidic ejector with a well plate, and fire the microfluidic ejector to eject the cell into the well plate. For instance, the computer-readable storage medium 813 may comprise instructions to operate the controller (as discussed herein), and the instructions, when executed, may cause the controller to align the microfluidic ejector with a reservoir in response to a determination that a cell is associated with the instance of signal change, and resume firing of the microfluidic ejector to expel the cell in the reservoir.

In some examples, the imaging apparatus used for capturing images of the microfluidic device includes a flat lens image array. In such examples, the computer-readable storage medium 813 may comprise instructions that, when executed, cause the controller to determine that a cell is associated with the instance of signal change, and align the microfluidic ejector with a first reservoir in response to a determination that the cell is of a first type, and align the microfluidic ejector with a second reservoir in response to a determination that the cell is of a second type.

The fluid contained in the channel may not be completely expelled when the microfluidic ejector is activated. In some examples, the computer-readable storage medium 813 may comprise instructions that, when executed, cause the controller to actuate the microfluidic ejector a plurality of times to cause a particular amount of the fluid contained in the channel to be expelled following a determination that a cell has passed into the channel. The plurality of times may be equivalent to a number of times that may result in the clearing of the fluid contained in the channel to ensure that the cell or other particle of interest is expelled from the channel. Thus, for instance, if a single activation of the microfluidic ejector results in a quarter of the fluid contained in the channel to be expelled, the controller may cause the microfluidic ejector to be activated four times following a determination that the cell or other particle of interest has passed into the channel.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
firing a microfluidic ejector of a microfluidic device to expel a fluid from a channel of the microfluidic device;
in response to detecting an instance of signal change from an impedance sensor disposed in the channel, controlling fluid ejection from the microfluidic ejector and capturing an image of the channel with an imaging apparatus;
using the captured image, determining whether passage of a cell into the channel is associated with the instance of signal change from the impedance sensor; and
based on the determination, firing the microfluidic ejector to dispense the fluid from the channel into a reservoir.

2. The method of claim 1, further including:
firing the microfluidic ejector to dispense the fluid from the channel into a first reservoir in response to a determination that a cell is not associated with the instance of signal change; and
firing the microfluidic ejector to dispense the fluid from the channel into a second reservoir in response to a determination that a cell is associated with the instance of signal change.

3. The method of claim 1, wherein the impedance sensor is a first impedance sensor, the method further including:
in response to confirming, using a second impedance sensor disposed in the channel, that the fluid includes a cell, dispensing the cell into the reservoir.

4. The method of claim 1, further including classifying the instance of signal change as a cell instance, a multiple cell instance, a dead cell instance, a non-cell instance, or combinations thereof.

5. The method of claim 1, further including:
dispensing the fluid in a first reservoir in response to determining that a cell is associated with the instance of signal change and the cell is of a first type; and
dispensing the fluid in a second reservoir in response to determining that a cell is associated with the instance of signal change and the cell is of a second type.

6. The method of claim 1, further including determining that a cell is associated with the instance of signal change and determining a morphological feature of the cell.

7. An apparatus, comprising:
a foyer in fluid communication with a channel and a microfluidic ejector, wherein the channel is to receive fluid via the foyer and the microfluidic ejector is to expel the fluid from the channel;
an impedance sensor disposed in the channel, the impedance sensor to detect an instance of signal change responsive to passage of a cell through the channel;
an imaging apparatus; and
a controller to:
pause firing of the microfluidic ejector responsive to an instance of signal change detected by the impedance sensor; and
determine whether a cell is associated with the instance of signal change by capturing an image of the channel using the imaging apparatus.

8. The apparatus of claim 7, wherein the imaging apparatus includes a lensless image array.

9. The apparatus of claim 7, wherein the imaging apparatus includes a camera, and a focusing lens.

10. The apparatus of claim 7, wherein the controller is to:
align the microfluidic ejector with a reservoir in response to a determination that a cell is associated with the instance of signal change; and
resume firing of the microfluidic ejector to expel the cell in the reservoir.

11. The apparatus of claim 7, wherein the imaging apparatus includes a flat lens image array.

12. The apparatus of claim 7, wherein the controller is to determine that a cell is associated with the instance of signal change, and:
align the microfluidic ejector with a first reservoir in response to a determination that the cell is of a first type; and
align the microfluidic ejector with a second reservoir in response to a determination that the cell is of a second type.

13. A non-transitory computer readable medium storing instructions that when executed cause a computing device to:
receive from an impedance sensor disposed in a channel of a microfluidic device, a signal indicating a change in impedance;
in response to detecting the instance of signal change from the impedance sensor disposed in the channel, control fluid ejection from a microfluidic ejector in the microfluidic device and capture an image of a channel of the microfluidic device;
using a learning-based process, identify particles in the channel; and
based on the results of the learning-based process, fire the microfluidic ejector to eject fluid from the channel into a reservoir.

14. The medium of claim 13, wherein the instructions to identify particles in the channel using a learning-based process include instructions that when executed cause the computing device to:
determine a region of interest within the captured image;
count particles within the region of interest; and
classify particles within the region of interest as a single cell, multiple cells, dead cells, non-cells, or combinations thereof.

15. The medium of claim 13, including instructions that when executed cause the computing device to:
in response to a determination that a cell is associated with the instance of signal change, communicate instructions to a movement control system to align the microfluidic ejector with a well plate, and fire the microfluidic ejector to eject the cell into the well plate.
